(19) United States
(12) Patent Application Publication
(10) Pub. No.: US 2002/0140690 A1
(43) Pub. Date: Oct. 3, 2002

(54) Computer with communicating separable computing display subsystem

(76) Inventors: Edward V. Gamsaragan, El Dorado Hills, CA (US); Varghese George, Folsom, CA (US); Peter J. Ruscito, Folsom, CA (US); Kurt B. Robinson, Newcastle, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/823,831

(22) Filed: Mar. 30, 2001

(51) Int. Cl. G09G 5/00

(52) U.S. Cl. 345/211

(57) ABSTRACT

A computer includes a computing display subsystem screen that includes a processor is detachably connected to the remainder of the computer. When the computing display subsystem is detached, communication may continue between the computing display subsystem and the base station using one of a plurality of techniques, including radio frequency or infrared communications.

### BACKGROUND

Portable computers have become increasingly popular because they can be used at one's normal workplace, using an AC adapter and a connection to normal line voltage, or they can be used away from one's normal workplace using a battery backup. For example, many users use a workstation computer at one location and transfer data from the workstation to the portable computer when they are traveling away from their regular workplace.

The size of portable computers, however, can have disadvantages relative to handheld devices. That is, handheld devices are more mobile and physically versatile when compared to portable computers, but the handheld computers lack the computing power of a portable computer.

Thus, there is a need for a portable computer, which is physically more versatile, without sacrificing substantial computing power.

For example, many users use a workstation computer at one location and transfer data from the workstation to the portable computer when they are traveling away from their regular workplace.

The size of portable computers, however, can have disadvantages relative to handheld devices. That is, handheld devices are more mobile and physically versatile when compared to portable computers, but the handheld computers lack the computing power of a portable computer.

Thus, there is a need for a portable computer, which is physically more versatile, without sacrificing substantial computing power.

### BRIEF DESCRIPTION OF THE DRAWING

FIG. 1 is a perspective view of a portable computer in accordance with one embodiment of the present invention;

FIG. 2 is a perspective view of the computer shown in FIG. 1 after the computing display has been detached;

FIG. 3 is a partial, enlarged view of a connector for connecting the computing display to the base station;

FIG. 4 is a partial, enlarged cross-sectional view showing the technique for removing the computing display from the base station;

FIG. 5 is a partial, enlarged view of a connector for connecting the computing display to the base station;

FIG. 6 is a partial, enlarged view of a connector for connecting the computing display to the base station; and

FIG. 7 is a block depiction of one exemplary embodiment of the computing display and base station.

### DETAILED DESCRIPTION

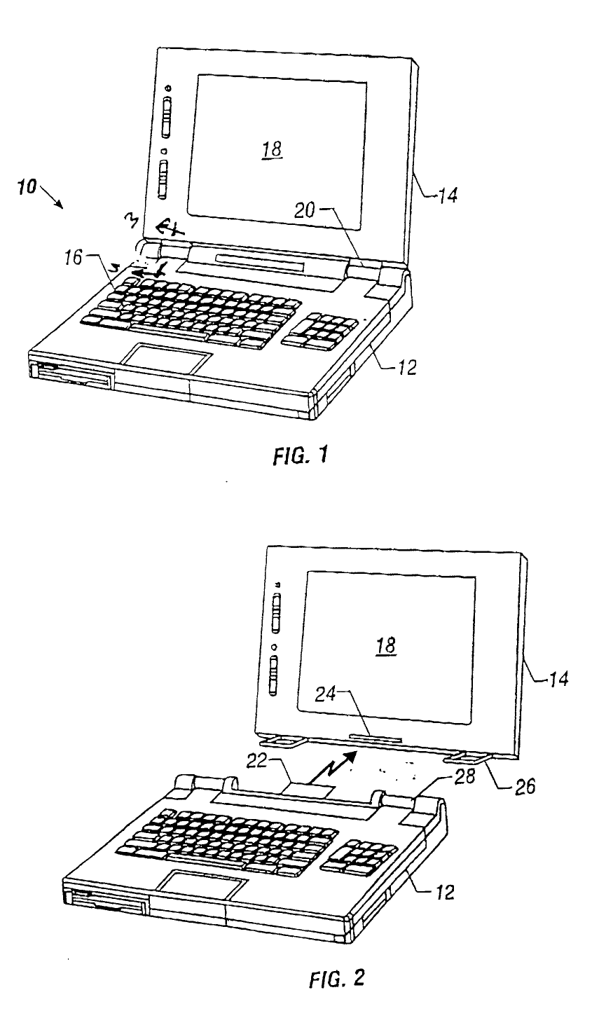

Referring to FIG. 1, a portable computer 10 includes a base station 12 with a keyboard 16 formed thereon. A computing display subsystem 14 is secured via hinges to the base station 12. When open, a display screen 18 is visible on the computing display subsystem 14.

The computing display subsystem 14 is detachably secured to the base station 12 and a communication link is provided to allow the base station 12 and computing display subsystem subsystem 14 to continue to communicate. That is, once the computing display subsystem 14 has been removed as shown in FIG. 2, it continues to communicate with the computer base station 12 as if they were still physically connected. This can be accomplished using any one of a variety of known techniques including an infrared communication link or a radio frequency communication link.

In an embodiment using a radio connector, as illustrated in FIG. 2, a radio link is established between transceiver 22 on the base station 12 and transceiver 24 on the computing display subsystem 14.

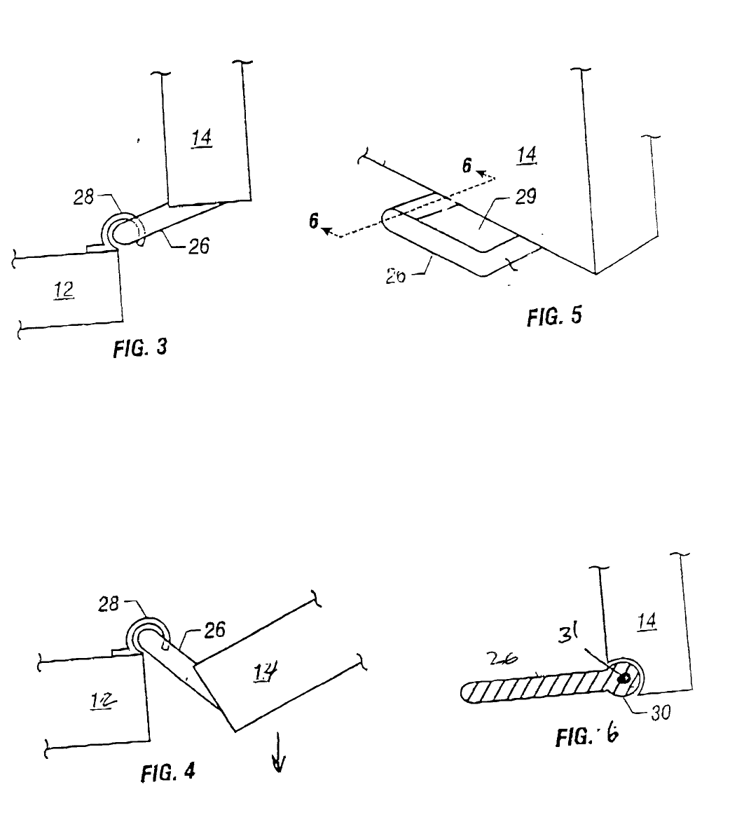

A variety of detachable connectors may be used to connect the computing display subsystem 14 to the base station 12. One exemplary embodiment, shown in FIG. 3, uses an open ring 28 which journals a shaft 26. The shaft 26 connects to the computing display subsystem 14 while the open ring 28 is connected to the base station 12. The ring 28 may apply a frictional force to the shaft 26 to allow the computing display subsystem 14 to be fixed at various desired angular orientations with respect to the base station 12.

When it is desired to remove the computing display subsystem 14, the computing display subsystem is simply rotated to the parallel position shown in FIG. 4. In this position, if the computing display subsystem 14 is pushed downwardly as indicated by the arrow, the shaft 26 springs out from the open ring 28 by biasing the ring outwardly.

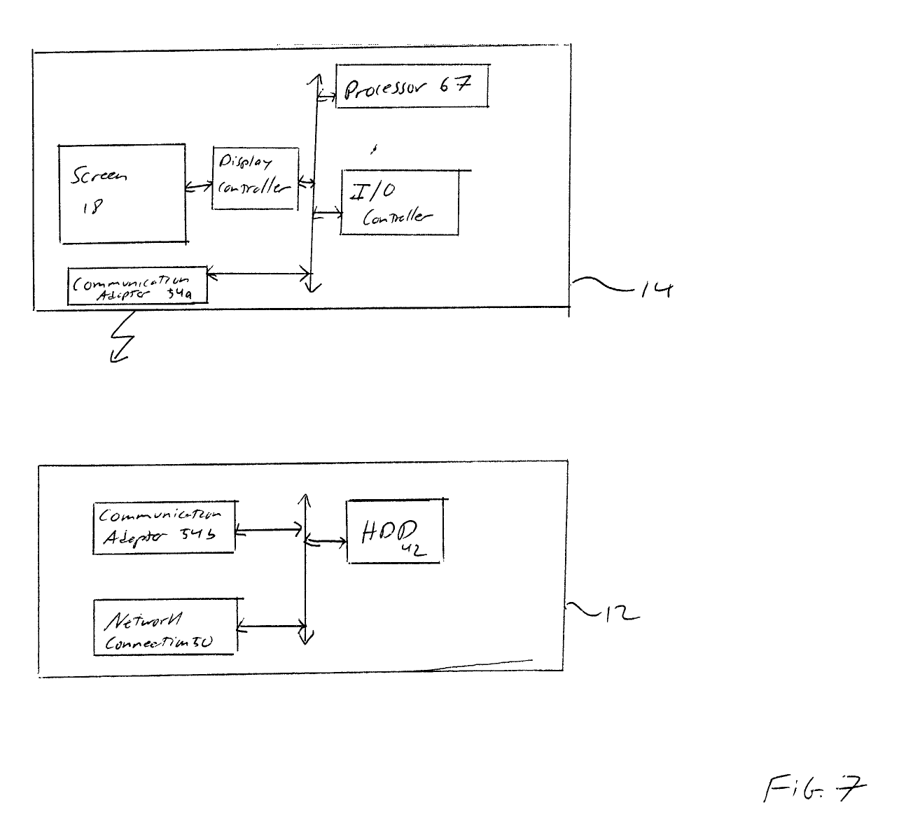

As shown in FIG. 5, the shafts 26 are connected by arms to the computing display subsystem 14. The rings 28 slip through the openings 29 between adjacent arms of the shaft. As shown in FIG. 6, the arms of the shaft are rotatably mounted on the computing display subsystem 14 using a tight pin 31 and ring 30 connection as illustrated in FIG. 6.

While one technique has been shown for removably connecting the base station 12 and computing display subsystem 14, those skilled in the art will appreciate numerous other connection techniques.

Referring to FIG. 7, in one embodiment the computing display subsystem 14, includes a processor 67, a display controller, a communication adapter 54a (i.e., to communicate via wirelessly with the base station), and a screen 18. In addition, the display may also include an I/O controller to receive data entered via the display. For example, in one embodiment, the display is a liquid crystal display (LCD) that is writeable to accept data input from a user. In alternative embodiment, other types of screens may be used to receive data input from a user.

In other alternative embodiments, the computing display subsystem 14 may further include devices such as non-volatile memory (e.g., flash memory, hard drives), and/or a volatile memory devices (e.g., Random Access Memory (RAM)). In yet other alternative embodiments, the computing display subsystem may include additional components/devices, without departing from the scope of the invention.

In one embodiment, the processor included in the computing display subsystem operates in two power modes (e.g., Intel® SpeedStep™ Technology). When the computing display subsystem is connected to the base station, which is receiving power from an AC outlet (alternating current), the processor in the computing display subsystem operates at a first mode that includes a higher frequency that consumes more power, relative to the second mode. When the computing display subsystem is disconnected from the base station, operating on battery power, the processor operates the second mode that includes a lower frequency and consumes less power relative the first mode of operation.

The computing display subsystem 14 may further include its own power supply 60. The power supply 60 may be either a battery power supply or may also include an AC adapter. The power supply 60 may be a separate power supply from that used to control the remainder of the computer 10. However it may also be used for a single AC adapter to be utilized with either or both of the base station 12 and computing display subsystem 14. In one embodiment, the display 14 may include a capacitive storage element, which stores charge drawn from the battery contained within the base station 12 to enable short term operation of the display while separated from the base station 12 [EVG2].

FIG. 7 further illustrates one embodiment of the base station 12 that includes a communication adapter 54b coupled to a storage device (e.g., a hard disk drive (HDD)) 42, and other input devices, such as a keyboard and mouse. The base station may also include a network connection 50, providing access to a Local Area Network (LAN) or Wide Area Network (e.g., the Internet). In an alternative embodiment, the base station 12 may further include a processor and additional memory devices, such as a RAM.

The computing display subsystem may communicate with the base station via the wireless connection to store and/or retrieve data from the HDD 42 in the base station. As a result, power consuming activities such as storage on a conventional HDD can remain at the base station to decrease power consumption of the computing display subsystem 14, while still allowing a user of the computing display subsystem 14 to have access to the HDD. In addition, a user of the computing display subsystem can access remote resources via the network connection 50 of the base station 12 [EVG2]. In an embodiment where the base station include a processor, compute intensive work can be performed by the base station to assist in preserving power in the computing display subsystem.

When separated, the base station and computing display subsystem 14 communicate through the pair of adapters 54a and 54b. The adapters 54a and 54b may be either infrared red (IR) adapters or radio frequency (RF) adapters, which allow communication over the intervening air space. In an embodiment using radio frequency to communicate between the computing display subsystem and the base station, a variety of radio links may be utilized. For example, in one embodiment, the radio link is a Bluetooth radio link (see www.bluetooth.com), which is a short-range, cable replacement, radio technology. It uses the 2.4 GHz Instrumentation, Science, Medical (ISM) unlicensed band. The radio link may be set to a nominal range of 10 meters augmentable with an external power amplifier to up to 100 meters. Seventy-nine hop frequencies are utilized beginning at the lowest frequency, which is 2402 MHz, and each of the 79 hop frequencies is 1 MHz above the next lower frequency.

A connection may be made between the computing display subsystem and the base station by sending a page message. A page message may include a train of page messages on different hop frequencies. For the application described herein, an Asynchronous Connectionless Link (ACL) may be used.

ACL provides one frame duration links with full duplex communications. ACL communications use a time division duplex scheme. A first slot provides a transmission from the master to the slave and a second slot provides a transmission from the slave to the master. Each slot is transmitted on a different hop frequency. The device initializing the transmission is designated the master and the device receiving the transmission is designated the slave.

While the present invention has been described with respect to a limited number of embodiments, those skilled in the art will appreciate numerous modifications and variations there from. It is intended that the appended claims cover all such modifications and variations as fall within the true spirit and scope of the present invention.

What is claimed is:

1. A computer comprising:
a base station, said base station having a storage device; and
a computing display subsystem detachably connectable to said base station, said computing display subsystem including a processor and a communication adapter that permits said computing display subsystem to communicate with said base station when said computing display subsystem is detached from said base station.

2. The computer of claim 1 wherein said computing display subsystem includes a power supply separate from the base station.

3. The computer of claim 1 wherein said computing display subsystem and said base station communicate using infrared signals.

4. The computer of claim 1 wherein said base station and said computing display subsystem communicate using radio frequency signals.

5. The computer of claim 1 wherein the computing display subsystem includes a writeable liquid crystal display.

6. The computer of claim 5 wherein the computing display subsystem includes a storage device.

7. The computer of claim 6 wherein the computing display subsystem includes a non-volatile storage device.

8. The computer of claim 1 wherein the communication adapter of the computing display subsystem communicates with the base station via a Bluetooth protocol.

9. The computer of claim 8 wherein said base station includes a keyboard and a connection to a network. The computer of claim 8 wherein said base station includes a processor.

10. The computer of claim 4 wherein the processor of the computing display subsystem operates at two separate power modes contingent on a power source.

11. A method of processing data comprising:
A base station having a storage device transmitting data to a computing display subsystem; and
the computing display subsystem detachably connectable to a base station, receiving the data from the base station, said computing display subsystem including a processor and a communication adapter that permits said computing display subsystem to communicate with the base station when said computing display subsystem is detached from said base station.

12. The method of claim 11, further including providing power to said computing display subsystem from a power supply separate from a base station power supply.

13. The method of claim 11 wherein said transmitting data to said computing display subsystem includes transmitting via infrared signals.

14. The method of claim 11 wherein said transmitting data to said computing display subsystem includes transmitting via radio frequency signals.

15. The method of claim 11 wherein the computing display subsystem includes a writeable liquid crystal display.

16. The method of claim 11 wherein the computing display subsystem includes a storage device.

17. The method of claim 16 wherein the computing display subsystem includes a non-volatile storage device.

18. The computer of claim 14 wherein said transmitting data to said computing display subsystem includes transmitting via radio frequency includes using a Bluetooth protocol.

19. A computing display subsystem comprising:
a processor;
a communication adapter that permits said computing display subsystem to communicate with a base station when said computing display subsystem is detached from said base station; and
a detachable connection to said base station.

20. The computing display subsystem of claim 19 wherein said computing display subsystem includes a power supply separate from the base station.

21. The computing display subsystem of claim 19 wherein said computing display subsystem and said base station communicate using infrared signals.

22. The computing display subsystem of claim 19 wherein said base station and said computing display subsystem communicate using radio frequency signals.

23. The computing display subsystem of claim 19 wherein the computing display subsystem includes a writeable liquid crystal display.

24. The computing display subsystem of claim 23 wherein the computing display subsystem includes a storage device.

25. The computing display subsystem of claim 24 wherein the computing display subsystem includes a non-volatile storage device.

26. The computing display subsystem of claim 19 wherein the communication adapter of the computing display subsystem communicates with the base station via a Bluetooth protocol.

27. The computing display subsystem of claim 22 wherein said base station includes a keyboard and a connection to a network.

28. The computing display subsystem of claim 19 wherein the processor of the computing display subsystem operates at two separate power modes contingent on a power source.
